(19) United States
(12) Patent Application Publication
(10) Pub. No.: US 2010/0120313 A1
(43) Pub. Date: May 13, 2010

(54) Packaging Material

(76) Inventors: Reinhard D. Bohme, Vancouver, WA (US); John Cameron Files, Vancouver, WA (US)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/616,371

(22) Filed: Nov. 11, 2009

Related U.S. Application Data
(63) Continuation-in-part of application No. 11/824,175, filed on Jun. 28, 2007, now abandoned.
Application No. 11/824,175 is a continuation-in-part of application No. 11/477,264, filed on Jun. 29, 2006, now abandoned.
Application No. 11/477,264 is a continuation-in-part of application No. PCT/US06/25557, filed on Jun. 29, 2006.
(60) Provisional application No. 60/695,145, filed on Jun. 29, 2005.
(60) Provisional application No. 60/817,488, filed on Jun. 29, 2006.
(60) Provisional application No. 61/247,983, filed on Oct. 2, 2009.

(51) Int. Cl. C09J 7/04; C09J 7/02; B05D 1/36

(52) U.S. Cl. 442/286; 428/349; 442/394; 427/407.1

(57) ABSTRACT

A packaging material for oily or greasy food items includes one or more features for resisting penetration, masking penetration, or for a combination of resisting and masking penetration by the oily or greasy substance.

### CROSS-REFERENCE TO RELATED APPLICATIONS

This application is a continuation-in-part of U.S. patent application Ser. No. 11/824,175, filed Jun. 28, 2007, which is a continuation-in-part of U.S. patent application Ser. No. 11/477,264, filed Jun. 29, 2006, and of PCT Application No. PCT/US2006/025557, filed Jun. 29, 2006, which claims the benefit of U.S. Provisional Application No. 60/695,145, filed Jun. 29, 2005, and U.S. patent application Ser. No. 11/824,175, filed Jun. 28, 2007, further claims the benefit of U.S. Provisional Application No. 60/817,488, filed Jun. 29, 2006. This application also claims the benefit of U.S. Provisional Application No. 61/247,983, filed Oct. 2, 2009. Each of the above applications is incorporated by reference in its entirety.

### BACKGROUND

Paper-based bags and cartons frequently are used to package frozen food items, such as French fries, hash browns, and breaded chicken. However, such products often are coated with oils that are capable of permeating the paper or paperboard. When oils penetrate the packaging, a darkened area or stain appears on the outside of the carton. Such staining detracts from the appearance of the packaging, which may be viewed as damaged or contaminated.

Recently, interest in low or non-trans fatty acid oils has increased because these oils are viewed as healthier than other oils. However, unlike other oils, which freeze at typical freezer temperatures, the non- or low trans fatty acid oils remain fluid, thereby causing greater staining to the package. Thus, there remains a need for packages and packaging materials that prevent staining by oils, mask staining by oils, or any combination thereof.

### SUMMARY

This disclosure relates generally to a packaging material and a method of making the packaging material.

In some instances, the material may be used for packaging a food item that is coated with or contains an oily or greasy substance, for example, a trans fatty acid oil, a low trans fatty acid oil, a non-trans fatty acid oil, a saturated oil, an unsaturated oil, grease, fat, or butter (collectively “oil” or “oils”), that potentially can penetrate one or more components of the packaging material. Accordingly, the packaging material may include features for resisting penetration, masking penetration, or for both resisting and masking oil penetration. It will be understood that any combination of the techniques and features disclosed herein or contemplated hereby may be used alone or in any combination as needed or desired. In one particular example, the packaging material may comprise a layered structure including one or more components that are susceptible to oil penetration and one or more components that are resistant to oil penetration. For example, the packaging material may include an oil permeable substrate coated with one or more additional layers that resist penetration by oil. Any of the numerous packaging materials described herein or contemplated hereby may be used to form bags or other packages or constructs for containing a food item. In one example, the packaging material is used to form a bag for containing a potato-based food item such as hash browns, French fries, pet food (e.g., cat food and/or dog food), or the like.

This disclosure also contemplates a method of making a packaging material having increased resistance to permeation by oil. The method includes providing a substrate that may be permeable to oil and, therefore, subject to staining, and substantially overlying at least a portion of the substrate with an oil resistant material or layer, for example, a resin or polymer. The oil resistant layer may include one or more additives optionally added to resin or film to impart additional functional characteristics, such as color, absorbency, improved adhesion, oil repellency, or numerous other attributes. A heat seal layer may be applied or joined to at least a portion of the oil resistant layer to allow the packaging material to be sealed. One or more tie layers may be included to improve adhesion (e.g., hot tack and/or seal strength) between various other layers. Still other layers may be incorporated to serve various other functions.

Other aspects and features of the present invention will become apparent in view of the figures and the following description.

### BRIEF DESCRIPTION OF THE DRAWINGS

The description refers to the accompanying drawings, some of which are schematic, in which like reference characters refer to like parts throughout the several views, and in which:

FIG. 1 is a schematic cross-sectional view of an exemplary packaging material;

FIG. 2 schematically depicts an exemplary process for forming the material of FIG. 1;

FIG. 3 schematically depicts an alternate process for forming the material of FIG. 1;

FIG. 4 is a schematic cross-sectional view of a variation of the exemplary packaging material of FIG. 1, including a stain masking layer;

FIG. 5 presents the hot tack strength of various structures that may be suitable for use as a packaging material; and

FIG. 6 presents the seal strength of various structures that may be suitable for use as a packaging material.

### DESCRIPTION

Various aspects of the invention may be illustrated by referring to the figures, which depict examples of packaging materials and exemplary process schematics for forming such materials. For purposes of simplicity, like numerals may be used to describe like features. Although several different exemplary aspects, implementations, and embodiments of the various inventions are provided, numerous interrelationships between, combinations thereof, and modifications of the various inventions, aspects, implementations, and embodiments are contemplated hereby.

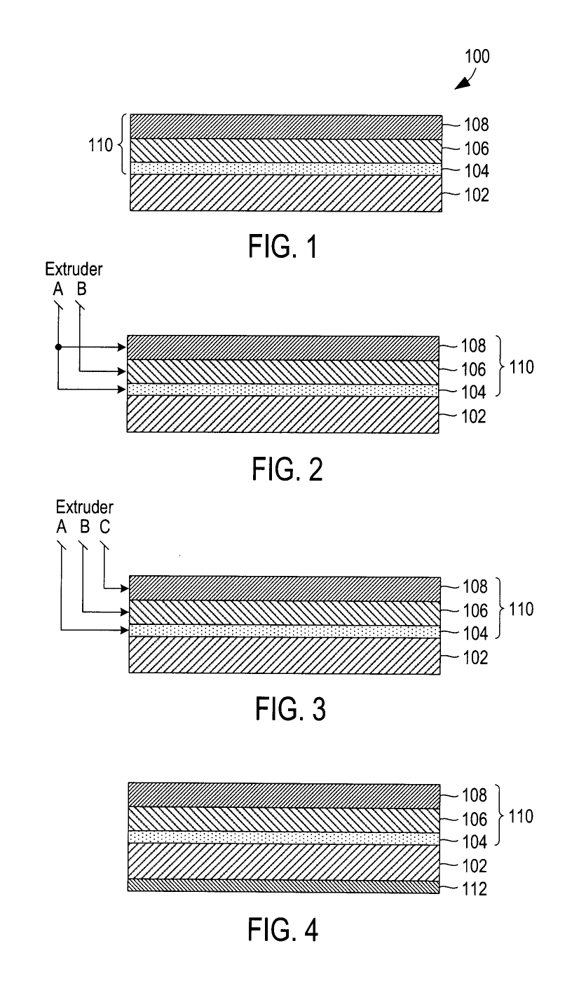

FIG. 1 depicts a schematic cross-sectional view of an exemplary packaging material 100. The packaging material 100 generally includes a plurality of layers including a substrate 102, a tie layer 104, a core layer 106, and a heat seal layer 108. Each layer 102, 104, 106, 108 is in a substantially facing, contacting relationship with the respective adjacent layer(s). When used to form a package (not shown), the heat seal layer 108 (i.e., the inner surface of the heat seal layer 108) generally faces the interior of the package and the substrate 102 (i.e., the outer surface of the substrate) generally faces outwardly from and/or defines the exterior of the package.

The substrate 102 generally comprises a base material from which the packaging material is formed. In some instances, the substrate may comprise a material that is susceptible to penetration and/or staining by oil, for example, paper or paperboard. The paper or paperboard may have a basis weight of from about 8 to about 250 lbs/ream, for example, about 20 to about 50 lbs/ream, for example, from about 35 to about 45 lbs/ream. Other ranges and basis weights are contemplated. In other instances, the substrate may comprise other materials, for example, a woven material, a nonwoven material, a polymer film, or any combination thereof. In one particular example, the substrate may comprise a woven polypropylene (PP). In another particular example, the substrate may comprise a polypropylene film. However, other substrates may be used.

The heat seal layer 108 may be used where, for example, thermal bonding is used to form a package (not shown) from the packaging material. The heat seal layer may be formed from any suitable thermoplastic polymer. Generally, the heat seal layer is formed from a material having a sufficiently low melting or softening point so the heat seal can be initiated at a relatively low temperature (“heat seal temperature”), for example, from about 180° F. to about 300° F. Additionally, the material used to form the heat seal layer may be selected to provide a wide hot tack sealing window, such that the heat seal may be formed over a range of temperatures with the degree of tackiness for the desired duration.

The heat seal layer 108 may be present in any suitable amount as needed or desired to achieve the desired heat seal. In each of various independent examples, the heat seal layer 108 may have a basis weight of from about 0.1 to about 20 lbs/ream, from about 1 to about 15 lbs/ream, from about 3 to about 10 lbs/ream, from about 3.5 to about 9 lbs/ream, or from about 2 to about 6 lbs/ream. Other ranges and basis weights are contemplated.

The core layer 106 generally comprises a base polymer layer, which may, if desired, impart various attributes to the packaging material. By way of example, and not limitation, the core layer 106 may serve as a barrier layer to oils (i.e., as an oil resistant layer). In some instances, the core layer 106 may be selected to have a melting point that is greater than the heat seal temperature to ensure that the integrity of the core layer 106 is maintained during the heat sealing process. In other instances, the core layer 106 may comprise a blend of materials, at least one of which may have a melting point less than the heat seal temperature. In such embodiments, the lower melting components may soften during the heat sealing process, such that a portion of the core layer 106 serves as a heat seal material or layer.

The core layer 106 may generally have a basis weight of from about 0.05 to about 25 lbs/ream. In each of various independent examples, the core layer 106 may have a basis weight of from about 1 to about 10 lbs/ream, from about 2 to about 6 lbs/ream, from about 3 to about 5 lbs/ream, from about 1 to about 3 lbs/ream, from about 2 to about 4 lbs/ream, or from about 2 to about 5 lbs/ream. Other ranges and basis weights are contemplated.

The bonding or tie layer 104 generally serves to join two adjacent layers, in this example, the core layer 106 and the substrate 102, where such layers are incompatible or otherwise unable to adhere to one another sufficiently. Other tie layers may be located between two polymer layers, two paper layers, a paper layer and a polymer layer, or between any other pair of layers. The tie layer 104 may have any suitable basis weight as needed to attain the desired level of adhesion between the adjacent layers. For example, the tie layer 104 may have a basis weight of from about 0.1 to about 5 lb/ream, for example, from about 0.25 to about 1 lb/ream. Other ranges and basis weights are contemplated.

While one specific structure 100 is illustrated schematically in FIG. 1, it will be appreciated that each of the layers may vary for each packaging application. Layers may be added or omitted as needed. It also will be appreciated that various materials may be used to form each layer of the packaging material, and that each layer may have various basis weights or coat weights, depending on the particular application. Further, it will be appreciated that each layer may serve more than one purpose in a particular packaging material, and that the layer names (e.g., heat seal layer 108, core layer 106, tie layer 104, substrate 102) are provided for convenience of explanation and not limitation in any manner.

The polymer system 110 (i.e., the heat seal layer 108, core layer 106, and bonding layer 104) may have any suitable total basis weight. In each of various examples, the polymer system may have a basis weight of about 5 lb/ream, about 5.5 lb/ream, about 6 lb/ream, about 6.5 lb/ream, about 7 lb/ream, about 7.5 lb/ream, about 8 lb/ream, about 8.5 lb/ream, about 9 lb/ream, about 9.5 lb/ream, about 10 lb/ream, about 10.5 lb/ream, about 11 lb/ream, about 11.5 lb/ream, about 12 lb/ream, about 12.5 lb/ream, about 13 lb/ream, about 13.5 lb/ream, about 14 lb/ream, about 14.5 lb/ream, about 15 lb/ream, or any other suitable basis weight.

The components of the polymer system 110 may be present in any suitable ratio. In one example, the weight % ratio of the heat seal layer 108, core layer 106, and tie layer 104 may be about 3.5:9:1. In another example, the weight % ratio of the heat seal layer 108, core layer 106, and tie layer 104 may be about 3.5:17:1. In still another example, the weight % ratio of the heat seal layer 108, core layer 106, and tie layer 104 may be about 3.5:18.2:1. In yet another example, the weight % ratio of the heat seal layer 108, core layer 106, and tie layer 104 may be about 3.5:22.7:1. Other ratios are contemplated.

Numerous exemplary embodiments are described below. However, it will be appreciated that numerous other embodiments are contemplated by the disclosure.

According to a first exemplary embodiment, a polymer blend may comprise linear low density polyethylene (LLDPE), low density polyethylene (LDPE), and an ethylene/methacrylic acid copolymer (EMA). The LLDPE may be a metallocene LLDPE (m-LLDPE). The ratio of each component may vary for each application. In one variation, the blend may comprise from about 60% to 100% LLDPE, from 0 to about 35% LDPE, and from 0 to about 5% EMA. In another variation, the blend may comprise from about 60% to about 80% LLDPE, from about 15% to about 35% LDPE, and from about 1 to about 5% EMA. In still another variation, the blend may comprise about 60% LLDPE, about 35% LDPE, and about 5% EMA, such that the ratio of the components is about 12:7:1. Other blends of LLDPE, LDPE, and EMA are contemplated.

If desired, the blend of LLDPE, LDPE, and EMA may be used as a heat seal material. The heat seal material may be used as a partial or complete layer 108 in combination with various other layers to form a packaging material 100, for example, as illustrated schematically in FIG. 1. The present inventors have found that a blend of LLDPE, LDPE, and EMA offers superior processability and resulting heat seal strength. Specifically, the present inventors have found that by adding LLDPE to LDPE, the melting point (and, therefore, the heat seal temperature) is lowered from about 230° F. to about 220° F., and that by adding EMA to the mixture of LLDPE and LDPE, the melting point (and, therefore, the heat seal temperature) of the blend is lowered to about 210-215° F. As a result, the heat seal may be initiated at a lower temperature, which allows for the packaging material 100 to be heat sealed at greater processing speeds. The present inventors have also found that the heat seal formed from the blend of LLDPE, LDPE, and EMA has superior strength relative to a heat seal formed from any of the individual components.

While various LLPDEs, LDPEs, and EMAs may be used, one example of an LLDPE that may be suitable for use is Dow Affinity PT 1450G1 (Dow Chemical Co., Midland, Mich.) (believed to be m-LLDPE). While not wishing to be bound by theory, it is believed that Dow Affinity PT 1450G1 LLDPE may include one or more components that may enhance the affinity with PP, as will be discussed further below. One example of an LDPE that may be suitable is Chevron 1018 LDPE (Chevron Phillips Chemical Co. LLC, The Woodlands, Tex.). Other examples of LDPEs that may be suitable include, but are not limited to, Westlake EC-482 (Westlake Chemical Corp., Houston, Tex.) and Marflex® 1013 LDPE (Phillips Chemical Co. LLC, The Woodlands, Tex.). One example of EMA that may be suitable is Surlyn® 1707 resin (DuPont Packaging and Industrial Polymers, Wilmington, Del.).

According to a second exemplary embodiment, the blend of LLDPE, LDPE, and EMA of the first exemplary embodiment may be used as a tie layer 104. The tie layer 104 may be used in combination with various other layers to form a packaging material 100, for example, as illustrated schematically in FIG. 1. In one variation, the tie layer 104 may comprise about 60% LLDPE, about 35% LDPE, and about 5% EMA.

The present inventors have discovered that this exemplary blend provides superior processability and adhesive properties with a variety of substrates. By way of illustration, and not limitation, it is well known that it is difficult to adhere polypropylene (PP) (e.g., in the core layer 106) to a paper substrate at high processing speeds. However, the exemplary blend of LLDPE, LDPE, and EMA, which has a relatively low melting point (about 210-215° F. as compared with about 320° F. for PP), tends to flow readily into the paper, even at high processing speeds (e.g., 2000-2500 ft/min). Additionally, where Dow Affinity 1450G1 LLPDE is used, the present inventors have found that the tie layer 104 has a greater affinity for core layers including PP, as compared with other LLDPEs. While not wishing to be bound by theory, it is believed that the Dow Affinity 1450G1 LLDPE includes one or more components that enhance the affinity of the LLPDE to PP.

Such improvements may also be seen with other substrates, for example, woven materials. The relatively low softening temperature of the blend generally allows the molten blend to flow readily into the spaces between the mesh without causing the mesh to soften undesirably, thereby forming a barrier to insects. Where the woven material comprises PP, even greater results have been observed with Dow Affinity 1450G1 LLDPE, as compared with other LLDPEs.

According to a third exemplary embodiment, a blend of LLDPE, LDPE, and EMA according to the first exemplary embodiment may be used to form both a heat seal layer 108 and a tie layer 104. The heat seal layer 108 and tie layer 104 may be used in combination with various other layers to form a packaging material 100, for example, as illustrated schematically in FIG. 1. In one variation, the blend for the heat seal layer 108 and/or the tie layer 104 may comprise about 60% LLDPE, about 35% LDPE, and about 5% EMA.

The heat seal layer 108 and tie layer 104 may be present in any suitable relative amount. In one example, the ratio of the weight % of the heat seal layer 108 to the tie layer 104 may be about 4:1, about 3.5:1, about 3:1, about 2.5:1, about 2.0:1, about 1.5:1, about 1:1, or any other suitable ratio. The ratios may be adjusted as needed to provide the desired characteristics of the heat seal layer 108 and the tie layer 104 (and the resulting packaging material), as will be understood by those in the art.

Such a packaging material advantageously may be formed using a two extruder system. By way of illustration, in this and other embodiments where two or more layers have the same composition, for example, layers 104, 108, one extruder may be used to form layers 104, 108, and another may be used to form layer 106, as shown schematically in FIG. 2. In such an embodiment, the ratio of the weight % of the heat seal layer 108 and the tie layer 104 may be adjusted as needed to optimize the amount of each layer needed to achieve its respective purpose. Specifically, the ratio may be adjusted to ensure both that the heat seal layer 108 is applied at a sufficient weight to form the desired heat seal and that the tie layer 104 is applied at a sufficient weight to ensure that the bond to the substrate is sufficient. Thus, it will be appreciated that in this and other embodiments where a single extruder is used to form both the heat seal layer 108 and the tie layer 104, the minimum total weight may need to be increased to achieve both objectives. Alternatively, each layer 104, 106, 108 of the material 100 may be formed using a separate extruder, as shown schematically in FIG. 3. In either scenario, one or more of the layers may be coextruded or may be formed and/or joined in a sequential manner. Numerous other processes are contemplated hereby.

According to a fourth exemplary embodiment, which may be considered a variation of the third exemplary embodiment, the core layer 106 may comprise PP. In such an embodiment, the core layer 106 may serve as an oil resistant layer, where needed. One example of a PP that may be suitable is Marlex® PP (Chevron Phillips, Kingsport, Tenn.). However, other PPs may be used. The heat seal layer 108 and the tie layer 104 may each comprise the blend of LLDPE, LDPE, and EMA according to the first exemplary embodiment, for example, about 60% LLDPE, about 35% LDPE, and about 5% EMA. The components of the polymer system 110 may be present in any suitable ratio. In one example, the weight % ratio of the heat seal layer 108, core layer 106, and tie layer 104 may be about 3.5:4.5:1.

In some variations of the fourth exemplary embodiment, the heat seal layer 108 may have a basis weight of from about 2 to about 4 lb/ream, the core layer 106 may have a basis weight of from about 3 to about 5 lb/ream, and the tie layer 104 may have a basis weight of from about 0.5 to about 1.5 lb/ream. In one specific example, the heat seal layer 108 may have a basis weight of about 3.12 lb/ream, the core layer 106 may have a basis weight of about 4 lb/ream, and the tie layer 104 may have a basis weight of about 0.88 lb/ream.

According to a fifth exemplary embodiment, which may be considered a variation of the third exemplary embodiment, the core layer 106 may comprise a blend of PP and LDPE. The relative amounts of PP and LDPE in the core layer 106 may vary for each application. The blend may generally comprise from about 70% to about 90% PP and about 10% to about 30% LDPE. In one exemplary embodiment, the blend may comprise about 75% PP and about 25% LDPE. In another exemplary embodiment, the blend may comprise about 80% PP and about 20% LDPE. In still another exemplary embodiment, the blend may comprise about 85% PP and about 15% LDPE. However, other suitable amounts and ratios of LDPE and PP may be used. The heat seal layer 108 and the tie layer 104 each comprise a blend of LLDPE, LDPE, and EMA, for example, about 60% LLDPE, about 35% LDPE, and about 5% EMA.

The present inventors have discovered these exemplary blends of PP and LDPE in the core layer 106 provide an excellent balance of properties for various packaging materials. For example, as compared with a core layer 106 comprising only PP (i.e., without the LDPE), a core layer 106 including from about 80 to about 85% PP and about 15 to 20% LDPE provides about the same level of oil resistance as a core layer 106 comprising 100% PP. Further, the presence of the LDPE improves adhesion with the adjacent layers. By way of example, where the heat seal layer 108 and/or the tie layer 104 comprise a blend of LLDPE, LDPE, and EMA (e.g., as discussed above), the blend of LDPE and PP in the core layer 106 has a greater affinity for the polymer blend of the heat seal layer 108 and/or the tie layer 104, as compared with PP alone.

Further, since LDPE has a lower melting point than PP (about 230° F. for LDPE and about 320° F. for PP), in some cases, depending on the heat seal temperature and other processing conditions, the LDPE in the core layer 106 and the tie layer 104 may soften during the heat sealing process, such that a part of the core layer 106 and tie layer 104 also effectively serves as part of the heat seal layer 108. In such cases, the basis weight of the heat seal layer 108 and/or the tie layer 104 may be reduced, thereby reducing the cost of the overall structure.

By way of illustration, the present inventors have found that a packaging material including:
a heat seal layer 108 having a basis weight of about 1.3 lb/ream and comprising a blend of about 60% LLDPE, about 35% LDPE, and about 5% EMA;
a core layer 106 having a basis weight of about 3.33 lb/ream and comprising an 80/20 blend of PP/LDPE; and
a tie layer 104 having a basis weight of about 0.37 lb/ream and comprising a blend of about 60% LLDPE, about 35% LDPE, and about 5% EMA, exhibited better peel strength (i.e., layer to layer adhesion) than a packaging material including:
a heat seal layer 108 having a basis weight of about 3.12 lb/ream and comprising a blend of about 60% LLDPE, about 35% LDPE, and about 5% EMA;
a core layer 106 having a basis weight of about 4 lb/ream and comprising PP; and
a tie layer 104 having a basis weight of about 0.88 lb/ream and comprising a blend of about 60% LLDPE, about 35% LDPE, and about 5% EMA.
   Thus, although each polymer system 110 had about the same basis weight (about 5 lb/ream), the packaging material including the blend of LDPE and PP in the core layer 106 exhibited superior peel strength at a reduced cost (based on the present cost of various polymers in each layer). While not wishing to be bound by theory, it is believed that this is because the presence of the LDPE in the core layer contributed to the overall heat sealability of the material, as discussed above.

Notably, the structure with the PP/LDPE core layer (2.66 lb/ream PP) also provided about the same level of oil resistance as the structure with about 4 lb/ream PP in the core layer. This is because the present inventors have discovered that oil resistance can be improved significantly by forming the packaging material in a specific manner. In particular, the present inventors have discovered that using a relatively low bond pressure (as compared with a typical bond pressure) to join the polymer system 110 to the substrate 102, the resulting weakly or loosely bonded structure exhibits greater oil resistance than a material formed using a high bond pressure (i.e., a highly or tightly bonded material) (see Example 12). Thus, in this and other embodiments, a low bond pressure may be used to enhance oil resistance, which may result in a lesser amount of PP needed to achieve the same results.

It will be appreciated that the terms “typical bond pressure”, “low bond pressure”, and “high bond pressure” are relative terms that may depend on the type of package being made and numerous other process variables. By way of example, and not limitation, for some packaging materials, a typical bond pressure may be from about 125 to about 200 psi, a low bond pressure may be less than 125 psi, for example, from about 60 to about 70 psi, for example, for about 65 psi, and a high bond pressure may be greater than about 200 psi, for example, about 400 psi. Numerous other bond pressures may be used. Additionally, it will be noted that in some embodiments, a combination of high bond pressures and low bond pressures may be used to provide the desired level of tensile strength, hot tack strength, seal strength and oil resistance in the resulting packaging material.

As discussed above, the components of the polymer system 110 may be present in any suitable ratio, for example, about 3.5:9:1, about 3.5:17:1, about 3.5:18.2:1, about 3.5:22.7:1, or any other suitable ratio.

In a first exemplary variation of the fifth exemplary embodiment, the heat seal layer 108 may have a basis weight of from about 0.5 to about 2 lb/ream, the core layer 106 may have a basis weight of from about 2 to about 12 lb/ream, and the tie layer 104 may have a basis weight of from about 0.1 to about 1 lb/ream.

In a second exemplary variation of the fifth exemplary embodiment, the heat seal layer 108 may have a basis weight of from about 0.5 to about 2 lb/ream, the core layer 106 may have a basis weight of from about 2 to about 4 lb/ream, and the tie layer 104 may have a basis weight of from about 0.1 to about 1 lb/ream. In one example, the heat seal layer 108 may have a basis weight of about 1.3 lb/ream, the core layer 106 may have a basis weight of about 3.33 lb/ream, and the tie layer 104 may have a basis weight of about 0.37 lb/ream.

In a third exemplary variation of the fifth exemplary embodiment, the heat seal layer 108 may have a basis weight of from about 0.5 to about 2 lb/ream, the core layer 106 may have a basis weight of from about 4 to about 8 lb/ream, and the tie layer 104 may have a basis weight of from about 0.1 to about 1 lb/ream. In one example, the heat seal layer 108 may have a basis weight of about 1.3 lb/ream, the core layer 106 may have a basis weight of about 6.33 lb/ream, and the tie layer 104 may have a basis weight of about 0.37 lb/ream.

In a fourth exemplary variation of the fifth exemplary embodiment, the heat seal layer 108 may have a basis weight of from about 0.5 to about 2 lb/ream, the core layer 106 may have a basis weight of from about 8 to about 12 lb/ream, and the tie layer 104 may have a basis weight of from about 0.1 to about 1 lb/ream. In one example, the heat seal layer 108 may have a basis weight of about 1.56 lb/ream, the core layer 106 may have a basis weight of about 10 lb/ream, and the tie layer 104 may have a basis weight of about 0.44 lb/ream. In another example, the heat seal layer 108 may have a basis weight of about 1.56 lb/ream, the core layer 106 may have a basis weight of about 8 lb/ream, and the tie layer 104 may have a basis weight of about 0.44 lb/ream.

According to a sixth exemplary embodiment, which may be considered a variation of the third exemplary embodiment, the core layer 106 may comprise LDPE. One example of an LDPE that may be suitable is Chevron 1018 LDPE (Chevron Phillips Chemical Co. LLC, The Woodlands, Tex.). However, other LDPEs may be used. The heat seal layer 108 and the tie layer 104 may each comprise a blend of LLDPE, LDPE, and EMA according to the first exemplary embodiment, for example, about 60% LLDPE, about 35% LDPE, and about 5% EMA.

The components of the polymer system 110 may be present in any suitable ratio. In one example, the weight % ratio of the heat seal layer 108, core layer 106, and tie layer 104 may be about 3.5:9:1.

In some variations of the sixth exemplary embodiment, the heat seal layer 108 may have a basis weight of from about 0.5 to about 2 lb/ream, the core layer 106 may have a basis weight of from about 2 to about 4 lb/ream, and the tie layer 104 may have a basis weight of from about 0.1 to about 1 lb/ream. In one specific example, the heat seal layer 108 may have a basis weight of about 1.3 lb/ream, the core layer 106 may have a basis weight of about 3.33 lb/ream, and the tie layer 104 may have a basis weight of about 0.37 to about 1 lb/ream.

If desired, at least one stain masking layer 112 may overlie a side of the substrate 102 opposite the tie layer 104, for example, as shown schematically in FIG. 4. The stain masking layer 112 may generally mask a stain, for example, by reducing or eliminating the darkened appearance of the stained substrate 102 (e.g., paper). In some examples, the stain masking layer 112 may comprise any suitable material that closely resembles the color of the stain, obscures the glossiness of the stain, or any combination thereof. In one example, the stain masking layer may comprise colorant mixture including a dark, non-reflective pigment, for example, carbon black, and a reflective pigment, for example, aluminum flake. The reflective pigment and non-reflective pigment may be used in any suitable ratio. In each of various examples, the colorant mixture may include carbon black and aluminum flake in a ratio of about 6.15:1, about 6:1, about 2.15:1, or about 2:1. Other ratios are contemplated. Further, the stain masking layer may include additional components if desired.

The stain masking layer 112 may have any suitable basis weight as needed to achieve the desired effect. In some embodiments, the basis weight of the stain masking layer may be from about 1 to about 6 lb/ream, for example, from about 2 to about 4 lb/ream.

According to a seventh exemplary embodiment, the substrate 102 of any of the previous embodiments may comprise paper. The paper may have a basis weight of from about 8 to about 250 lbs/ream, for example, about 20 to about 50 lbs/ream. In one specific example, the paper may have a basis weight of from about 35 to about 45 lbs/ream. In another specific example, the paper may have a basis weight of about 38 lb/ream. In yet another specific example, the paper may have a basis weight of about 43 lb/ream. In still another specific example, the paper may have a basis weight of about 50 lb/ream.

Alternatively, according to an eighth exemplary embodiment, the substrate 102 of any of the previous embodiments may comprise a woven material. In one variation, the woven material may comprise a woven PP. However, other woven materials are contemplated.

Alternatively still, according to an eighth exemplary embodiment, the substrate 102 of any of the previous embodiments may comprise a polymer film. In one variation, the polymer film may comprise PP. However, other polymer films are contemplated.

It will be appreciated that numerous other packaging materials are contemplated by the disclosure, and that each of such packaging materials may include various layers. Further, each of the various layers may have any suitable weight, and may be present in the packaging material in any suitable relative amount.

By way of example, as stated previously, in some embodiments, the heat seal layer 108 may comprise a blend of LLDPE, LDPE, and EMA. Alternatively, the heat seal layer 108 may comprise other polyethylenes (PEs) (e.g., EXXCO 012 PE, Exxon Mobil, Irving, Tex.), PP (including any of numerous metallocene catalyzed PPs (m-PP)), or any other suitable material or blend of materials.

Although particular examples are provided herein, it will be understood that other polymers, such as, but not limited to, any of those described herein, or any blends or copolymers thereof, may be used. For example, it may be desirable to blend the heat seal layer 108 polymer with the polymer used to form the adjacent layer, in this example, the core layer 106. Alternatively, a portion of the heat seal layer 108 polymer may be replaced with a copolymer of the heat seal layer 108 polymer and the core layer 106 polymer, such that the layers are more compatible and are able to attain better adhesion properties.

The core layer 106 likewise may be formed from any suitable polymer or polymer blend. In some embodiments, such as those described above, the core layer 106 may comprise PP, LDPE, or a blend of PP and LDPE. In other embodiments, the core layer 106 may additionally or alternatively comprise m-PP, other PEs, propylene-ethylene copolymers, including random propylene-ethylene copolymers, polyethylene terephthalate (PET) (e.g., PA10, Toray Plastics America, Inc., Front Royal, Va.), nylon 6,6, polyvinylidene chloride (PVdC) (e.g., Saran®, Dow Chemical Co., Midland, Mich.), polyvinyl alcohol (PVOH) (e.g., Elvanol®, DuPont, Wilmington, Del.), or ethylene vinyl alcohol (EVOH) (e.g., Eval Resins, Evalco, Houston, Tex.), or any combination thereof.

If desired, the core layer 106 may include other additives and/or components. Such additives or components may be selected to improve adhesion to the substrate or to other layers or components within the packaging material, to increase resistance to oil permeation, or to provide other functions or attributes. In one example, PP may be blended with organic or inorganic filler, for example, talc, calcium carbonate, magnesium carbonate, silica, calcium oxide, alumina, titanium dioxide, any other filler, or any combination thereof. In still another example, PP may be blended with LDPE and calcium carbonate. For example, the core layer 106 may include PP, LDPE, and from 0 to about 30 wt % filler (e.g., calcium carbonate), for example, from about 10 to about 30 wt % filler, for example, from about 5 to about 20 wt % filler. While such examples are provided herein, numerous other additives and components are contemplated hereby. It will be understood that some of such fillers, additives, and components also may alter other characteristics, for example, the opacity, of one or more layers and/or the packaging material in its entirety.

The tie layer 104 may be formed from any suitable polymer that sufficiently adheres to the adjacent layers. In one example, the tie layer 104 may comprise a blend of LLDPE, LDPE, and EMA, as described above in the exemplary embodiments. Alternatively, the tie layer 104 may comprise LDPE, m-PP, or any other suitable polymer or blends or copolymer thereof. In some instances, it may be desirable to blend the tie layer 104 polymer with the polymer used to form the adjacent layer, in this example, the core layer 106. Alternatively, a portion of the tie layer 104 polymer may be replaced with a copolymer of the tie layer 104 polymer and the core layer polymer, such that the layers are more compatible and are able to attain better adhesion properties.

If desired, any of the various packaging materials may include one or more features or components that mask staining of a substrate by oil. It has been found that oil may cause some substrates to become translucent or transparent, thereby creating a visibly darker area (i.e., stain) on, for example, paper or paperboard, particularly where there is a score, seam, abrasion, aperture, or slit through the material. Accordingly, at least a portion of the packaging material may be modified to mask the appearance of a darkened region created by oil penetration.

Various approaches for masking a stain are contemplated. Examples of such approaches include, but are not limited to, the use of one or more opacity modifying additives, opacity modifying fibers, colorants, and/or various printing patterns to minimize the appearance of a darkened region of a substrate. The opacity modifying additives, colorants, or combination thereof, may be applied or incorporated throughout one or more layers of the material, may be applied or incorporated in a pattern, may be selectively applied or incorporated in particular areas, may be applied or incorporated in a somewhat random manner, or any combination thereof, as appropriate.

In one example, the appearance of an oil stain may obscured (i.e., partially or completely reduced) by at least one stain masking layer overlying all or a portion of the side of the substrate viewed by the user (e.g., layer 112 of FIG. 4). As mentioned previously, the stain masking layer may include one or more colorants, i.e., any substance designed to impart color to the surface of the substrate. Thus, the term colorant is intended to include, for example, pigments, inks, paints, or any combination thereof. Colorants also may modify other attributes of the material, such as opacity and brightness, as will be appreciated by those skilled in the art.

The colorant type and composition selected and amount applied to or incorporated into the substrate may vary depending on the type of substrate chosen, the basis weight of the substrate, the modified or natural opacity of the substrate, the type of food item being packaged, the amount of oil on the food item, the degree of staining that occurs, the color of the stain on the substrate, and whether a combination of techniques are used to mask the appearance of staining. Thus, while various examples are provided herein, it will be understood the numerous other combinations of substrates and colorants are contemplated hereby.

In each of various examples, the stain masking layer (or combination of stain masking layers) may have a basis weight of from about 0.1 to about 10 lbs/ream, from about 1 to about 8 lbs/ream, from about 2 to about 4 lb/ream, about 1 lbs/ream, about 1.5 lbs/ream, about 2 lbs/ream, about 2.5 lbs/ream, about 3 lbs/ream, about 3.5 lb/ream, about 4 lb/ream, about 4.5 lb/ream, or in any other amount as needed or desired for a particular application.

If desired, the specific color of the colorant may be chosen to resemble closely or to overpower the appearance of a stain on the substrate caused by oil permeating through the substrate. In this manner, the colorant serves to mask the stain and, thus, to make it more difficult for the user from detecting the oil stain on the outside surface of the finished package. While the use of any color is contemplated hereby, dark colors, such as black or grey, may be particularly suitable for concealing the color variation associated with an oil stain. Such colors absorb a full, or nearly full, spectrum of light, thereby blocking or concealing the portions of the substrate that have become transparent or translucent due to oil staining. Furthermore, it may be advantageous to use an inorganic colorant. Such colorants tend to be more opaque, as compared with organic pigments, which often are somewhat translucent.

The masking efficiency of the ink or other colorant may be enhanced using a metallic or other reflective pigment. While not wishing to be bound by theory, the presence of such a pigment in the ink or colorant composition is believed to enhance stain masking because the metallic ink reflects light, thereby obscuring the glossy appearance of the oil stained colorant and/or substrate. Examples of reflective pigments that may be suitable for use with the present invention include aluminum flake, brass flake, pearlescent pigments, or other light reflecting pigments, or any combination thereof. Some examples of pearlescent pigments that may be suitable for use with the present invention include those offered by EM Industries, Inc. Some examples of reflective pigments that may be suitable for use with the present invention are Blitz Aluminum Powders and Blitz Goldbronze Powder (Benda-Lutz Co.). Other materials are contemplated hereby.

Thus, in one aspect, a colorant mixture or composition used in accordance with the present disclosure may include a pigment that at least partially conceals (i.e., substantially matches) the color of an oil stain on the particular substrate, for example, a non-reflective pigment. In another aspect, a colorant composition used in accordance with the present disclosure may include a pigment that at least partially obscures (i.e., substantially matches) the glossiness associated an oil stain on the particular substrate, for example, a reflective pigment. In yet another aspect, a colorant composition may include a first pigment, for example, a non-reflective pigment, that at least partially conceals the color of an oil stain and a second pigment, for example, a reflective pigment, that at least partially obscures the glossiness associated with the oil stain.

Thus, in each of various examples, the colorant composition independently may include from 0 to about 10% reflective pigment and from about 90% to 100% non-reflective pigment, from about 10% to about 20% reflective pigment and from about 80% to 90% non-reflective pigment, from about 20% to about 30% reflective pigment and from about 70% to 80% non-reflective pigment, from about 30% to about 40% reflective pigment and from about 60% to 70% non-reflective pigment, from about 40% to about 50% reflective pigment and from about 50 to 60% non-reflective pigment, from about 50% to about 60% reflective pigment and from about 40% to 50% non-reflective pigment, from about 60% to about 70% reflective pigment and from about 30% to 40% non-reflective pigment, from about 70% to about 80% reflective pigment and from about 20% to 30% non-reflective pigment, from about 80% to about 90% reflective pigment and from about 10% to 20% non-reflective pigment, or from about 90% to 100% reflective pigment and from 0 to 10% non-reflective pigment.

In each of various other examples, the colorant composition independently may include from 0 to about 10% aluminum flake and from about 90% to 100% carbon black, from about 10% to about 20% aluminum flake and from about 80% to 90% carbon black, from about 20% to about 30% aluminum flake and from about 70% to 80% carbon black, from about 30% to about 40% aluminum flake and from about 60% to 70% carbon black, from about 40% to about 50% aluminum flake and from about 50% to 60% carbon black, from about 50% to about 60% aluminum flake and from about 40% to 50% carbon black, from about 60% to about 70% aluminum flake and from about 30% to 40% carbon black, from about 70% to about 80% aluminum flake and from about 20% to 30% carbon black, from about 80% to about 90% aluminum flake and from about 10% to 20% carbon black, or from about 90% to 100% aluminum flake and from 0 to 10% carbon black.

In each of still other examples, the colorant composition independently may include from about 1% to about 50% aluminum flake and from about 50% to about 99% carbon black, from about 20% to about 40% aluminum flake and from about 60% to about 80% carbon black, from about 30% to about 50% aluminum flake and from about 50% to about 90% carbon black, from about 20% to about 60% aluminum flake and from about 40% to about 80% carbon black, from 0 to about 50% aluminum flake and from about 50% to 100% carbon black, or any other amount or range of amounts of each component.

In each of yet other examples, the colorant composition may include about 86% carbon black and about 14% aluminum flake, about 85.7% carbon black and about 14.3% aluminum flake, about 75.3% carbon black and about 24.6% aluminum flake, or about 75% carbon black and about 25% aluminum flake.

If desired, the one or more pigments may be blended into a stable emulsion of binder, vehicle, wax, and dispersing liquid, such as water or another suitable solvent, to form a colorant composition.

In some cases, stain masking may be enhanced by applying or incorporating the colorant in a solid, patterned, or random configuration. In some instances, a random printing pattern or randomly printed pattern may enhance masking of stains by camouflaging the variation in color of the stained substrate, for example, where the stains tend to appear around exhaust air slits in the package. In other instances, a solid or patterned configuration may achieve the desired degree of masking.

Alternatively or additionally, one or more opacity modifying additives may be used to mask the appearance of oil stains. Examples of opacity modifying additives that may be suitable include titanium dioxide, calcium carbonate, talc, or clay, and any combination thereof. It will be understood that some opacity modifying additives are also colorants, and that some colorants are also opacity modifying additives.

For example, an opacity modifying additive may be incorporated into the substrate to make the substrate more white and opaque. In one particular example, titanium dioxide is added to the substrate. For example, from about 20 to about 180 lb/ton titanium dioxide may be added to a paper having a basis weight of from about 15 to about 160 lbs/ream, or in any amount needed to achieve the desired results. In one particular example, from about 20 to about 180 lb/ton titanium dioxide may be added to a paper having a basis weight of from about 30 to about 50 lbs/ream. In one particular example, the opacity modifying additive may comprise at least about 90 lbs of titanium dioxide per ton of paper.

As another example, a layer of polymer containing titanium dioxide or other opacity modifying additive may be coated onto, extruded onto, laminated to, or otherwise applied to the substrate. To do so, the opacity modifying additive may be blended or compounded with a polymer and subsequently metered into an extruder, so that the polymer extrusion contains a substantially uniform amount of the opacifying agent. Such layers may be added, for example, as one or more layers of a multilayer structure, such as those described above, or may be applied directly to the substrate without other polymer layers. Where such a polymer layer is used, the packaging material may be formed into a package such that the opacified polymer layer lies on the inside of the package in contact with the food item and/or on the outside of the package, as needed or desired for a particular application.

As still another example, where the substrate is paper-based, bleached fibers that tend to be whiter may be used to form the substrate instead of or in addition to unbleached wood pulp fibers. Generally, from 0 to 100 wt %, for example, at least about 25%, of the fibers used to form the substrate may be bleached fibers. Other ranges and ratios of fiber types are contemplated hereby.

The opacity of the unmodified substrate may depend on numerous factors, for example, what the substrate is formed from and what the basis weight of the substrate is. Thus, by adding an opacity modifying additive, opacity modifying fibers, or opacity modifying layers, the opacity of the substrate may increase in various relative amounts.

It will be understood that the various opacity modifying additives, opacity modifying fibers, and/or colorants (collectively “masking additives”) described herein or contemplated hereby may be incorporated into the material in any suitable manner. In one example, the masking additive may be incorporated into the substrate 102 during formation of the substrate. Thus, where the substrate is paper or paperboard, the additive may be added during the wet end processing of the pulp. Where the masking additive is an opacity modifying additive, opacity modifying fiber, or colorant, this advantageously may result in a substantial distribution of additive throughout the bulk of the substrate. Alternatively, the masking additive may be incorporated into other layers, for example, the tie layer 104, core layer 106, and/or heal seal layer 108, or any other layers present in the structure.

In another example, the masking additive may be applied to the substrate or any other layer after formation. Thus, for example, where the masking additive is a colorant, the colorant may be applied to the surface of the substrate (or packaging material). Any suitable process may be used, including any of numerous spraying, roll coating, brush coating, saturating, printing, foaming, and other techniques. In one particular example, printing may be used to apply one or more stain masking layers to the surface of the substrate.

Any combination of processes may be used to form a material according to the present disclosure. Thus, for example, one colorant, such as carbon black, may be printed on the outside, and another colorant, such as titanium dioxide, may be added to the paper as a wet end constituent.

In each of the various aspects discussed herein, it will be understood by those of skill in the art that one or more processing additives may be incorporated into any of the various compositions or layers as needed or desired. Thus, for example, some such layers or compositions may include surfactants, anti-foaming agents, plasticizers, and additives to modify abrasion resistance and slip. Other processing additives are contemplated hereby.

It will be understood that any combination of techniques and features described herein or contemplated hereby may be used in accordance with the invention. Various aspects of the present invention are illustrated further by the following examples, which are not to be construed as limiting in any manner.

### Example 1

Use of an oil resistant layer in a packaging material was evaluated using the Oil Resistance Test (described below). A blend of 68 wt % Marlex® PP (Phillips Sumika, The Woodlands, Tex.), 20 wt % EC 482 LDPE (Westlake Chemical Corp., Houston, Tex.), and 12 wt % calcium carbonate obtained from Bayshore under the trade name BL-910 was prepared. The calcium carbonate was added to improve adhesion to the substrate. About 4 lbs/ream of the composition was extrusion coated onto natural Kraft paper having a basis weight of about 38 lbs/ream. An about 4 lbs/ream layer of EC 482 LDPE including heat seal additives was then extruded on top of the PP as the heat seal layer. This composition effectively adhered to the paper substrate and provided good resistance to non-trans fatty acid oil as measured by the Oil Resistance Test, as follows.

First, a 6 inch by 10 inch sample sheet was prepared. Two hard folds were made on one side of the sample material, so the two folds made a cross at the center of one side of the pouch. The sheet was folded in half and the short sides were sealed carefully. One tablespoon of sand was placed into a beaker to which 1 plastic eye-dropper of red-dyed non-trans fatty acid oil was added and mixed. The red, oily sand was spooned into the pouch, making sure not to contaminate the seal area with sand or oil. The sides of the pouch were pressed to remove as much air as possible. The open end of the pouch was heat sealed. (Any sample in which the seal is contaminated, creased, or otherwise not well formed was discarded.) Five sample pouches were prepared and placed on blotter paper.

For room temperature evaluation, each batch of five samples was observed at room temperature, typically at about 72° F. and about 50% humidity, for signs of red oil soak-thru every hour for the first two hours, and then about every 3 hours thereafter for 24 hours.

For evaluation at 50° C., each batch of five samples was placed in an oven maintained at about 50° C. The samples were observed for red oil soak-thru about every 20 minutes for the first two hours, and then every hour thereafter for 24 hours.

For evaluation at 80° C., each batch of five samples was placed in an oven maintained at about 80° C. The samples were observed for red oil soak-thru about every 10 minutes for the first hour, every 30 minutes thereafter for 8 hours, and thereafter every 3 hours for 24 hours.

The amount of red stain at each time interval was reported and averaged. A sample has failed when about 25% of the surface shows red oil soak-thru. As stated above, the packaging material exhibited good resistance to oil when evaluated according to this procedure.

### Example 2

The effectiveness of a masking colorant composition including a metallic pigment was compared with composition without a metallic pigment. The compositions evaluated are presented below.

### Ink Formulation I

### Black

about 20 wt % carbon black pigment

about 23 wt % other components (e.g., binder, resin, surfactant, wax)

remainder water

### Ink Formulation II “Pewter”

### Slight Metallic Cast

about 14 wt % carbon black pigment

about 4.7 wt % aluminum flake

about 21 wt % other components (e.g., binder, resin, surfactant, wax)

remainder water

### Ink Formulation III

### Metallic Silver-Black

about 6.7 wt % carbon black pigment

about 9.8 wt % aluminum flake

about 20 wt % other components (e.g., binder, resin, surfactant, wax)

remainder water

### Ink Formulation IV

### Black with Slight Metallic Cast

about 17.48 wt % carbon black pigment

about 7.77 wt % aluminum flake

about 69.88 wt % other components (e.g., binder, resin, surfactant, wax)

remainder water

The ink compositions were coated onto the smooth side of the paper in amount of about 1 lb dry/ream. Then, about 6 lbs/ream of LDPE was extrusion coated onto the wire side of paper having a basis weight of about 40 lbs/ream. The various compositions effectively masked staining, as indicated in Table 1.

TABLE 1

| | Formula 1 | Formula II | Formula III | Formula IV |
|---|---|---|---|---|
| Description | Carbon black | Carbon black | Carbon black | Carbon black |
| | | w/aluminum flake | w/aluminum flake | w/aluminum flake |
| | | (about 6.15:1) | (about 2.26:1) | (about 2.25:1) |
| Masking | Fair masking; | Excellent masking; | Outstanding masking; | Superb masking; |
| Effectiveness | grease stain faint | visible on close | oil stains barely | oil stains barely |
| | but discernible | inspection | discernible | discernible |

### Example 3

Use of a printed masking pattern was evaluated. A flexographic print plate was prepared from a picture of a large tub of potatoes. The picture included light and dark areas that define the shape of potatoes. Formulae I, II, and III of Example 2 were printed onto a natural Kraft paper having a basis weight of about 40 lbs/ream in the desired pattern. The results are presented in Table 2.

TABLE 2

| | Formula 1 | Formula II | Formula III |
|---|---|---|---|
| Masking | Good; grease | Excellent; | Superb; oil stains |
| Effectiveness | stain faint but | stain is scarcely | nearly invisible, even |
| | discernible | visible on close | with close inspection |
| | | inspection | |

### Example 4

A flexible, substantially two-dimensional, oil resistant packaging material was formed from a layer of paper coated with an oil resistant polymer. The coated paper was formed into a pouch or package in which oily products were sealed and handled. Oil stains that typically are visible on the outside of the sealed package were less visible or not visible at all.

### Example 5

A black ink was printed in a solid configuration on the outside surface of the packaging material of Example 4, thereby rendering oil stains more difficult to see compared to non-printed portions of the paper.

### Example 6

An ink containing about 96% carbon black and about 4% finely divided aluminum pigment was printed in a solid configuration on the outside surface of the packaging material of Example 4. Oil stains were masked effectively.

### Example 7

An ink containing about 10% finely divided aluminum and about 90% carbon black was printed in a solid configuration on the outside surface of the packaging material of Example 4. Oil stains were masked effectively.

### Example 8

A 100% carbon black ink was printed onto the outside surface of the packaging material of Example 4 in various configurations. A random printing pattern of lighter and darker shades was more effective at stain masking than a solid printing pattern.

### Example 9

An ink containing about 96% carbon black and about 4% finely divided aluminum was printed onto the outside surface of the packaging material of Example 4 in various configurations. A random printing pattern was more effective at masking stains than a solid printing pattern.

### Example 10

An ink containing about 90% carbon black and about 10% finely divided aluminum was printed onto the outside surface of the packaging material of Example 4 in various configurations. A solid printing pattern was more effective at masking stains than a random printing pattern.

### Example 11

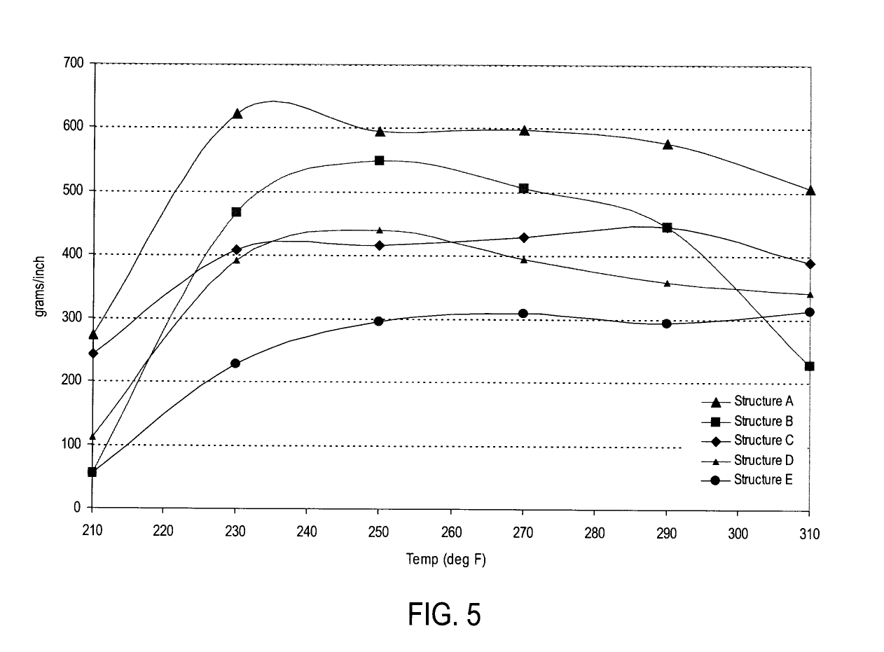

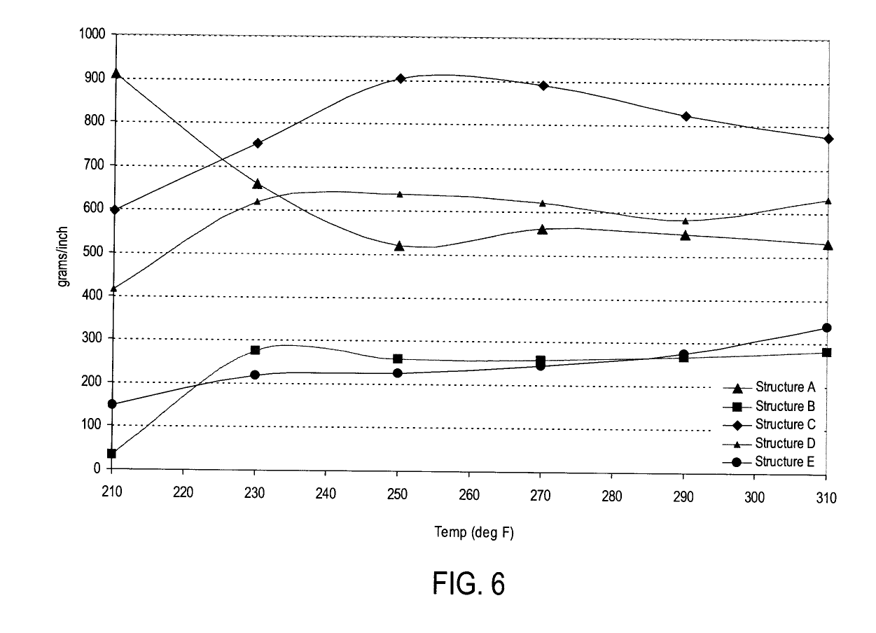

The hot tack strength and seal strength of various structures was evaluated using ASTM 1921-98 with a Lako Tools SL-10 Hot Tack and Seal Strength Tester over a temperature range of 210° F. to 310° F. at 20° F. intervals. The results are presented in Tables 3 and 4 and FIGS. 5 and 6. The structures evaluated were as follows:
Structure A:
   about 3.12 lb/ream blend A
   about 4.0 lb/ream PP
   about 0.88 lb/ream blend A
   about 38# natural Kraft paper
Structure B:
   about 3.12 lb/ream blend B
   about 4.0 lb/ream PP
   about 0.88 lb/ream blend B
   about 38# natural Kraft paper
Structure C:
   about 1.30 lb/ream blend A
   about 3.33 lb/ream LDPE
   0.37 lb/ream blend A
   38# natural Kraft paper
Structure D:
   about 1.30 lb/ream blend A
   about 3.33 lb/ream 80%/20% PP/LDPE
   about 0.37 lb/ream blend A
   about 38# natural Kraft paper
Structure E:
   about 1.30 lb/ream blend B
   about 3.33 lb/ream 80%/20% PP/LDPE
   about 0.37 lb/ream blend B
   about 38# natural Kraft paper

where:
Blend A:
   about 60% Dow Affinity PT 1450G1 LLPDE
   about 35% Chevron 1018 LDPE (8MI)
   about 5% DuPont Surlyn 1707 EMA
Blend B:
   about 95% Chevron 1018 LDPE (8MI)
   about 5% DuPont Surlyn 1707 EMA

TABLE 3
Hot tack strength (g/in)

| Jaw Temp | Structure | Structure | Structure | Structure | Structure |
|---|---|---|---|---|---|
| (° F.) | A | B | C | D | E |
| 210 | 272 | 54 | 242 | 112 | 54 |
| 230 | 621 | 466 | 408 | 391 | 228 |
| 250 | 594 | 548 | 415 | 439 | 295 |
| 270 | 598 | 506 | 429 | 395 | 309 |
| 290 | 576 | 445 | 446 | 359 | 294 |
| 310 | 506 | 227 | 390 | 342 | 313 |

As is evident from FIG. 5 and Table 3, the hot tack strength of Structures A and D, which include the LLDPE, was significantly higher (about 34% higher for Structure A; about 29% higher for Structure D) than the hot tack strength of Structures B and E, which are similar structures without the LLDPE.

TABLE 4
Seal strength (g/in)

| Jaw Temp | Structure | Structure | Structure | Structure | Structure |
|---|---|---|---|---|---|
| (° F.) | A | B | C | D | E |
| 210 | 910 | 32 | 596 | 414 | 147 |
| 230 | 659 | 275 | 753 | 619 | 217 |
| 250 | 519 | 256 | 903 | 639 | 223 |
| 270 | 562 | 256 | 891 | 620 | 243 |
| 290 | 551 | 266 | 822 | 584 | 275 |
| 310 | 530 | 280 | 775 | 632 | 338 |

As is evident from FIG. 6 and Table 4, the seal strength of Structures A and D, which include the LLDPE, was significantly higher (about 60% higher for Structure A; about 59% higher for Structure D) than the seal strength of Structures B and E, which are similar structures without the LLDPE.

### Example 12

The hot tack strength and seal strength of tightly bonded areas (bond pressure of about 400 psi) and loosely bonded areas (bond pressure of about 65 psi) of various structures was evaluated using ASTM 1921-98 with a Lako Tools SL-10 Hot Tack and Seal Strength Tester over a temperature range of 210° F. to 310° F. at 20° F. intervals. The results are presented in Table 5. The structures evaluated were as follows (with Structures A, C, and D being the same as Structures A, C, and D of Example 11):
Structure A:
   about 3.12 lb/ream blend A
   about 4.0 lb/ream PP
   about 0.88 lb/ream blend A
   about 38# natural Kraft paper
Structure C:
   about 1.30 lb/ream blend A
   about 3.33 lb/ream LDPE
   about 0.37 lb/ream blend A
   about 38# natural Kraft paper
Structure D:
   about 1.30 lb/ream blend A
   about 3.33 lb/ream 80%/20% PP/LDPE
   about 0.37 lb/ream blend A
   about 38# natural Kraft paper
Structure F:
   about 1.56 lb/ream blend A
   about 4.0 lb/ream 80%/20% PP/LDPE
   about 0.44 lb/ream blend A
   about 38# natural Kraft paper
Structure G:
   about 1.82 lb/ream blend A
   about 4.66 lb/ream 80%/20% PP/LDPE
   about 0.52 lb/ream blend A
   about 38# natural Kraft paper

where:
Blend A:
   about 60% Dow Affinity PT 1450G1 LLPDE
   about 35% Chevron 1018 LDPE (8MI)
   about 5% DuPont Surlyn 1707 EMA

TABLE 5

| | Structure | Structure | Structure | Structure | Structure |
|---|---|---|---|---|---|
| | A | C | G | F | D |
| Polymer system (lb/ream) | about 8 | about 5 | about 7 | about 6 | about 5 |
| Hot tack strength, loosely | — | 444 | 482 | 473 | 395 |
| bonded area (g/in) | | | | | |
| Hot tack strength, tightly | 598 | 471 | 574 | NT | NT |
| bonded area (g/in) | | | | | |
| Seal strength, loosely | NA | 891 | 657 | 713 | 620 |
| bonded area (g/in) | | | | | |
| Seal strength, tightly | 562 | 835 | 873 | — | — |
| bonded area (g/in) | | | | | |
| Oil resistance, loosely | — | — | excellent | excellent | good |
| bonded area | | | | | |
| Oil resistance, tightly | excellent | NT | NT | NT | fair |
| bonded area | | | | | |

Notably, the seal strength of Structure G exceeded that of Structure A in the tightly bonded areas, despite the fact that a lower weight polymer system was used. While not wishing to be bound by theory, it is presumed that the improved seal strength can be attributed to the presence of LDPE in the core layer.

Additionally, it is noted that the loosely bonded areas of Structures F and G provided about the same level of oil resistance as the tightly bonded areas of Structure A, despite the fact that a lower weight polymer system was used in Structures F and G.

Further, it is noted that in Structure D, the loosely bonded areas provided greater oil resistance than the tightly bonded areas.

The various layers of the packaging material may be formed, assembled, and/or joined using any method or technique known in the art. Thus, for example the polymer layers may be coextruded and laminated to the paper layer. In another example, each layer may be formed independently and laminated together using heat, adhesive, mechanical fastening, or other joining or binding technique. In yet another example, the polymer layers may be extruded directly onto the paper layer, concurrently or sequentially. Numerous other processes are contemplated hereby.

In this and other aspects, the packaging material may be formed into any suitable package, for example, a bag. The bag may have any shape and size as needed for a particular food item and application. For some applications, for example, for French fries, the bags may include slits or other features to permit the air to escape after filling the bag. This allows a plurality of bags to be packed more efficiently into boxes or other cartons for shipping.

Any suitable process may be used to form and fill the bag. In many of such processes, heat is used to seal the open ends of the package together. However, any suitable adhesive, mechanical fastening, joining, or binding technique may be used.

Although certain embodiments of this invention have been described with a certain degree of particularity, those skilled in the art could make numerous alterations to the disclosed embodiments without departing from the spirit or scope of this invention. All directional references (e.g., over, under, inner, outer, upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other. Further, all percentages herein are weight percentages, unless specified otherwise.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. A packaging material comprising:
a substrate;
a core layer;
a tie layer disposed between and joining the substrate to the core layer; and
a heat seal layer overlying the core layer on a side of the core layer opposite the tie layer, the heat seal layer being an outermost layer comprising a blend of linear low density polyethylene, low density polyethylene, and ethylene/methacrylic acid copolymer.

2. The packaging material of claim 1, wherein the blend of linear low density polyethylene, low density polyethylene, and ethylene/methacrylic acid copolymer comprises about 60% linear low density polyethylene, about 35% low density polyethylene, and about 5% ethylene/methacrylic acid copolymer.

3. The packaging material of claim 1, wherein the linear low density polyethylene is metallocene linear low density polyethylene.

4. The packaging material of claim 1, wherein the tie layer comprises the blend of linear low density polyethylene, low density polyethylene, and ethylene/methacrylic acid copolymer.

5. The packaging material of claim 4, wherein the linear low density polyethylene is metallocene linear low density polyethylene.

6. The packaging material of claim 1, wherein the core layer comprises a polyolefin.

7. The packaging material of claim 6, wherein the core layer comprises at least one of polypropylene and low density polyethylene.

8. The packaging material of claim 1, wherein the substrate comprises paper.

9. The packaging material of claim 1, wherein the substrate comprises a polypropylene film.

10. The packaging material of claim 1, wherein the substrate comprises a woven polypropylene.

11. The packaging material of claim 1, wherein the substrate comprises a nonwoven polypropylene.

12. The packaging material of claim 1, wherein the weight percent ratio of the heat seal layer, core layer, and tie layer is about 3.5:4.5:1.

13. The packaging material of claim 1, wherein the weight percent ratio of the heat seal layer, core layer, and tie layer is about 3.5:9:1.

14. The packaging material of claim 1, wherein the weight percent ratio of the heat seal layer, core layer, and tie layer is about 3.5:17:1.

15. The packaging material of claim 1, wherein the weight percent ratio of the heat seal layer, core layer, and tie layer is about 3.5:18.2:1.

16. The packaging material of claim 1, wherein the weight percent ratio of the heat seal layer, core layer, and tie layer is about 3.5:22.7:1.

17. The packaging material of claim 1, wherein
the heat seal layer has a basis weight of from about 2 to about 4 lb/ream,
the core layer has a basis weight of from about 3 to about 5 lb/ream, the core layer comprising polypropylene, and
the tie layer has a basis weight of from about 0.5 to about 1.5 lb/ream, the tie layer comprising the blend of linear low density polyethylene, low density polyethylene, and ethylene/methacrylic acid copolymer.

18. The packaging material of claim 1, wherein
the heat seal layer has a basis weight of from about 0.5 to about 2 lb/ream,
the core layer has a basis weight of from about 2 to about 4 lb/ream, the core layer comprising low density polyethylene, and
the tie layer has a basis weight of from about 0.1 to about 1 lb/ream, the tie layer comprising the blend of linear low density polyethylene, low density polyethylene, and ethylene/methacrylic acid copolymer.

19. The packaging material of claim 18, further comprising a stain masking layer overlying a side of the substrate opposite the tie layer.

20. The packaging material of claim 19, wherein the stain masking layer comprises carbon black and aluminum flake in a ratio of about 2.25 to 1.

21. The packaging material of claim 1, wherein
the heat seal layer has a basis weight of from about 0.5 to about 2 lb/ream,
the core layer has a basis weight of from about 2 to about 12 lb/ream, the core layer comprising low density polyethylene and polypropylene, and
the tie layer has a basis weight of from about 0.1 to about 1 lb/ream, the tie layer comprising the blend of linear low density polyethylene, low density polyethylene, and ethylene/methacrylic acid copolymer.

22. The packaging material of claim 21, wherein the core layer has a basis weight of from about 2 to about 4 lb/ream.

23. The packaging material of claim 21, wherein the core layer has a basis weight of from about 4 to about 8 lb/ream.

24. The packaging material of claim 21, wherein the core layer has a basis weight of from about 8 to about 12 lb/ream.

25. The packaging material of claim 21, further comprising stain masking layer overlying a side of the substrate opposite the tie layer.

26. The packaging material of claim 25, wherein the stain masking layer comprises carbon black and aluminum flake in a ratio of about 2.25 to 1.

27. The packaging material of claim 1, formed into a package.

28. The packaging material of claim 1, formed into a package for receiving a food item containing an oil.

29. A packaging material comprising a plurality of layers including an outermost layer comprising a blend of linear low density polyethylene, low density polyethylene, and ethylene/methacrylic acid copolymer.

30. A method of making a packaging material, comprising:
applying a polymer system on a first side of a substrate, the polymer system including an outermost layer comprising a blend of linear low density polyethylene, low density polyethylene, and ethylene/methacrylic acid copolymer.

31. The method of claim 30, wherein the polymer system comprises an innermost layer comprising a blend of linear low density polyethylene, low density polyethylene, and ethylene/methacrylic acid copolymer, the innermost layer being adjacent to the substrate.

32. The method of claim 31, wherein the polymer system comprises an intermediate layer disposed between the innermost layer and the outermost layer, the intermediate layer comprising at least one of polypropylene and low density polyethylene.

33. The method of claim 30, further comprising applying pressure to the polymer system on the substrate.

34. The method of claim 30, further comprising applying a stain masking layer to a second side of the substrate opposite the first side.
